(19) United States
(12) Patent Application Publication
(10) Pub. No.: US 2022/0391563 A1
(43) Pub. Date: Dec. 8, 2022

(54) Computer-Assisted Design Method for Mechatronic Systems

(71) Applicant: Kontrol GmbH, Waldhausen im Strudengau (AT)

(72) Inventor: Michael Naderhirn, Waldhausen im Strudengau (AT)

(21) Appl. No.: 17/881,006

(22) Filed: Aug. 4, 2022

Related U.S. Application Data
(63) Continuation of application No. 16/303,827, filed on Nov. 21, 2018, now abandoned.

(51) Int. Cl. G06F 30/20

(52) U.S. Cl. CPC G06F 30/20; G06F 2111/10

(57) ABSTRACT

A method for computer-assisted system design includes: providing a textual system description that defines a desired behavior of a vehicle; converting, using a computer, the textual system description into a linear temporal logic (LTL) formula; converting, using the computer, the LTL formula into a first automaton; providing, using the computer, a second automaton representing system dynamics of the vehicle; and generating, using the computer, a testing automaton by combining the first and the second automaton.

### TECHNICAL FIELD

The present disclosure relates to systems and method for the automated design of mechatronic systems, particularly

### BACKGROUND

Today a lot of mechatronic systems are developed and sold without satisfying important safety standards. The reason for that fact is that the required cost and time effort to develop according to the applicable safety standards is relatively high. Therefore, only “high-end” applications like e. g. in the field of aeronautic industry rigorously applies this standards in the system design.

Depending on the application, mechatronic systems should be developed according to different safety standards such as, for example, ISO 26262 (titled: “Road vehicles—Functional safety”) in the field of automotive industry, IEC62061 (titled “Safety of machinery: Functional safety of electrical, electronic and programmable electronic control systems”) for safety of machines, EN51028 in the field of railway industry, or DO254/DO178C in the field of aeronautic industry in order to satisfy, e.g., the E.U. Machinery Directive. Most of them are derived from the meta-standard IEC 61508. In order to do that typically a so-called V-model is an accepted system development process applied in the system design (software and hardware design) according these standards (see FIG. 1).

In order to develop and design a system in accordance with the V-model a lot of development time is needed for testing, documentation and verification. As an illustrative example, FIG. 2 shows a simplified development process used by BAE Systems plc. Generally, the starting point of the workflow is a textual requirements specification. In the next step, a system software model is developed (e. g. using the common numerical computing environment Matlab/Simulink) which complies with the requirements specification. To prove compliance with the requirements specification a review is then done by an independent developer (four eye principle) in the case of low criticality or additional by a third party reviewer (six eye principle) in the case of high criticality of the system.

In order to decrease the development cost The MathWorks, Inc. introduced several Matlab-based tools which allow for a partial automation of the development process. These tools include automatic code generation, automatic traceability of changes of the requirements in the models, automatic test design as well as verification and validation of the system design. Looking back to the V-model development cycle (see FIG. 1) these tools automate its the lower part (three boxes in the lower two levels of the V-Model) as seen in FIG. 3. The boxes above (in the top three levels of the V-Model) indicate manual work which must be performed “manually” by engineers.

### SUMMARY

A method for computer-assisted system design of dynamic systems is described herein. In accordance with one embodiment the method comprises: providing a textual system description; converting, using a computer, the textual system description into a linear temporal logic LTL formula; converting, using a computer, the LTL formula into a first automaton; providing, using a computer, a second automaton representing the system dynamics; and generating, using a computer, a testing automaton by combining the first and the second automaton.

The method described herein allows for a partial automation of the system design and verification process according to the well-known V-model. In one example, the method may further include: generating a hardware description language (HDL) model of the testing automaton; and implementing, using a computer, the testing automation in hardware. IN one example, the textual system description may be automatically enhanced to include redundancy.

The conversion of the textual system description into an LTL formula may include: decomposing the textual system description into keywords, which represent logic operators and modal temporal operators of a linear temporal logic (LTL), and text passages linked by the keywords; generating, using a computer, software function definitions corresponding to the text passages linked by the keywords; generating the LTL formula based on the software function definitions and the operators defined by the keywords. In one example, the process of providing a second automaton representing the system dynamics may include: providing a model representing the system dynamics; discretizing the model to obtain a discrete model; and converting the discrete model into an automaton. Various option of how this discretization is accomplished are described in the detailed description below.

Moreover, a controller module for controlling a dynamic system is described. According to one example, the controller module includes a controller unit executing a controller task to control the dynamic system, a hardware unit executing a testing automaton, which can be designed according to the method summarized above, and at least one sensor to obtain sensor information. The controller unit provides one or more set-points to the hardware unit, which is configured to check, based on the sensor information, whether one or more set-points are compliant with the textual system description.

The method summarized above may be implemented as a software product that performs the method when the software is executed on a computer.

### BRIEF DESCRIPTION OF THE DRAWINGS

The invention can be better understood with reference to the following description and drawings. The components in the figures are not necessarily to scale, emphasis instead being placed upon illustrating the principles of the invention. Moreover, in the figures, like reference numerals designate corresponding parts.

In the drawings:

FIG. 1 shows the V-model for mechatronic applications;

FIG. 2 shows the simplified workflow according the V-model by John Russell of BAE during his presentation at the Matlab EXPO 2015;

FIG. 3 shows the automation of the lower part of the V-model by using tools as offered by Mathworks® here shown as green boxes;

FIG. 4 shows the degree of automation achievable by the method presented herein;

FIG. 5 is a visualization of an exemplary system specification;

FIG. 6 shows the different function heads generated from the function non-translatable text;

FIG. 7 shows the result the procedure to convert both formulas into automata;

FIG. 8 shows the result of a linearization of a non-linear system;

FIG. 9 shows the result of an environment-driven discretization;

FIG. 10 is an example of a transition system as shown in Wikipedia;

FIG. 11 illustrates an exemplary transition matrix for the transition system of FIG. 10;

FIG. 12 illustrates different way to represent an environmental based discretization;

FIG. 13 shows the automata for a controller based discretization of the above dynamics;

FIG. 14 shows an exemplary situation to be tested;

FIG. 15 shows the results of the verification for different waypoints WP1 . . . WPn;

FIG. 16 shows the integration of a camera, OBD device with a function;

FIG. 17 shows a potential integration test for a camera which should detect a traffic light; and

FIG. 18 summarizes the automation of the development process of an exemplary mechatronic system (such as an autonomous car).

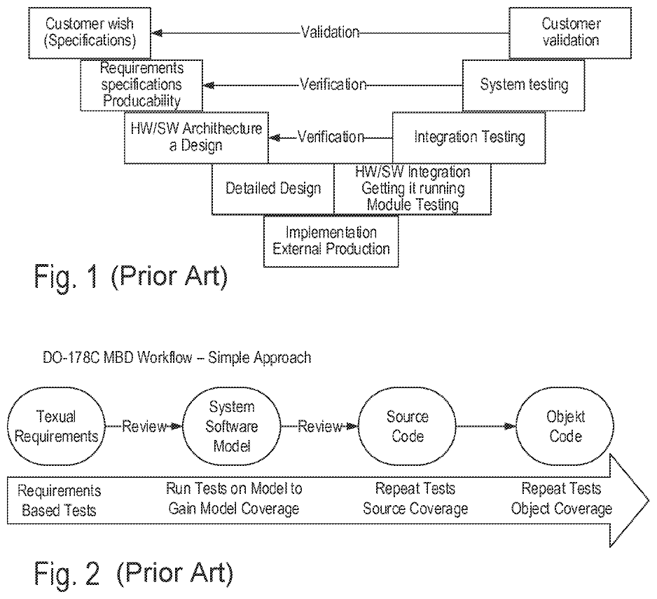

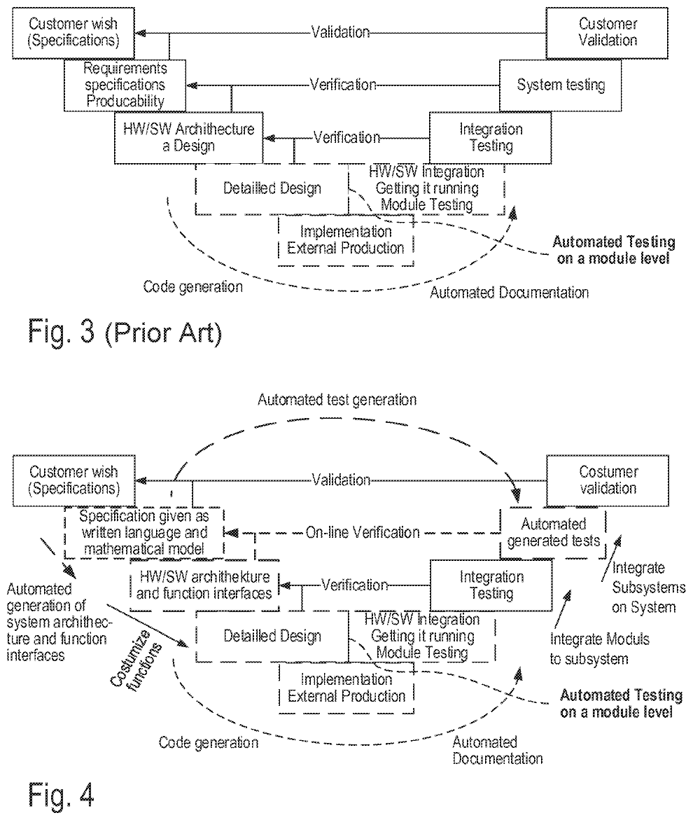

### DETAILED DESCRIPTION

With the method and systems described below a (semi-)automation of the process, which has been described in the Background section, may be achieved to further decrease the cost of the V-model development cycle. FIG. 4 illustrates the degree of automation achievable with the method described herein.

### (a) Language Conversion and Specification

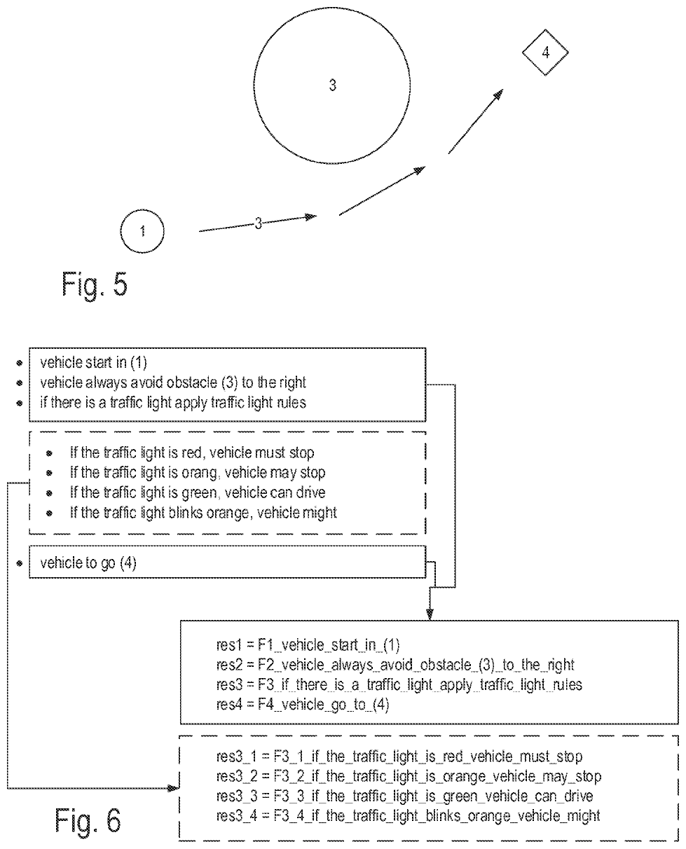

A text is given as a specification to define the behavior of a vehicle. For example (see FIG. 5):
vehicle start in (1),
vehicle always stay in environment
vehicle always avoid obstacle (3) to the right
vehicle go to (4)
   Additionally, the specification may include traffic rules like provided, for example, in the applicable laws and regulations.
If there is a traffic light apply traffic light rules,
   If the traffic light is red, vehicle must stop,
   If the traffic light is orange, vehicle may stop,
   If the traffic light is green, vehicle can drive,
   If the traffic light blinks orange, vehicle might,
      The text can be given as paragraphs and sub-paragraphs.

In the next step the effect onto a potential system failure is analyzed for each line of the above text. ISO 61508 and other similar standards use the so called Failure Mode and Effects Analysis (FMEA) or similar techniques to estimate the criticality level of a text line. Depending on the standard used, this can be done using the risk priority number (RPN). The procedure on how to obtain the RPN depends on the used standard and will not be discussed here as it can be found in the according standards.

The results of the FMEA analysis are tests and its testing requirements and/or the criticality level and/or other elements which must be considered during the design process of the function. Tests and its testing requirement defines e. g. the necessary detection rate or precision of a function (including sensor) to be tested, so that the function can be considered safe enough to be used on the system. This is especially important for integration tests (will be explained later). The criticality level can lead to design recommendations of the function e. g. the function must be redundant and system structure of the design must provide corresponding redundancy.

After applying the mentioned procedures each sentence will have some information about the necessary tests and its testing requirements and the recommended system structure which can be stored like

red traffic light vehicle must stop; redundant; 1e-3 detection rate; . . . ; . . . ;
To use both texts as requirements specification they are used as written but modified by words which are used to define linear temporal logic (LTL) or its extensions. Such words are
Not
Or
And
Always
Eventually
Next
. . .
   Applying these words in the above example may result in

```
vehicle always
stay in environment
and
avoid obstacle (3) to the right
and
do not drive faster then 50 km/h
and
apply traffic light rules
  red traffic light vehicle must stop
  or
  yellow traffic light vehicle should stop
  or
  green traffic light vehicle must drive
  or
  not working traffic light apply normal traffic rules
```

In the case that an information of one sentence requires redundancy or a special system design in the next step, a program uses this information in order to add these requirements to the text. This additional requirements must follow the standards if available (e. g. IEC 61508). As a simple example it is referred to the above example to make the “red light”-sentence redundant. The result of the processing could look like:

```
vehicle always
stay in environment
and
avoid obstacle (3) to the right
and
do not drive faster then 50 km/h
and
apply traffic light rules
  red traffic light vehicle must stop
    red traffic light vehicle must stop_1
    or
    red traffic light vehicle must stop_2
  or
  yellow traffic light vehicle should stop
  or
  green traffic light vehicle must drive
  or
  not working traffic light apply normal traffic rules
```

Subsequently, a program is applied which converts all lines, which are not keywords into function definitions (see FIG. 6). The function definitions can be generated for any programming language like C/C++ or for high level programming languages like Matlab/Simulink. In the next step, the translatable text is converted into an LTL formula using pattern matching and it is combined with the results of the functions. Referring to FIG. 6, a sub-paragraph is written in

LTL=res1 [symbol] res2 [symbol] res3 [symbol] res4

and the second one is

res3=(res3_1 [symbol] res3_2 [symbol] res3_3 [symbol] res3_4)

If a keyword is found it is replaced by a corresponding functional operator (NOT (¬), OR ( [symbol] ), AND ( [symbol] ), ALWAYS (G), Eventually (F), NEXT (X), etc.). The resulting LTL formula is then converted into a (Büchi) automaton (e.g. Büchi Automaton, which is a type of ω-automaton, which extends a finite automaton to infinite inputs) or similar state machine using a method as proposed, for example, in one of the following internet publications:
en.wikipedia.org/wiki/Linear_temporal_logic_to_B%3%BCchi_automaton or
www.lsv.ens-cachan.fr/˜gastin/lt2ba/

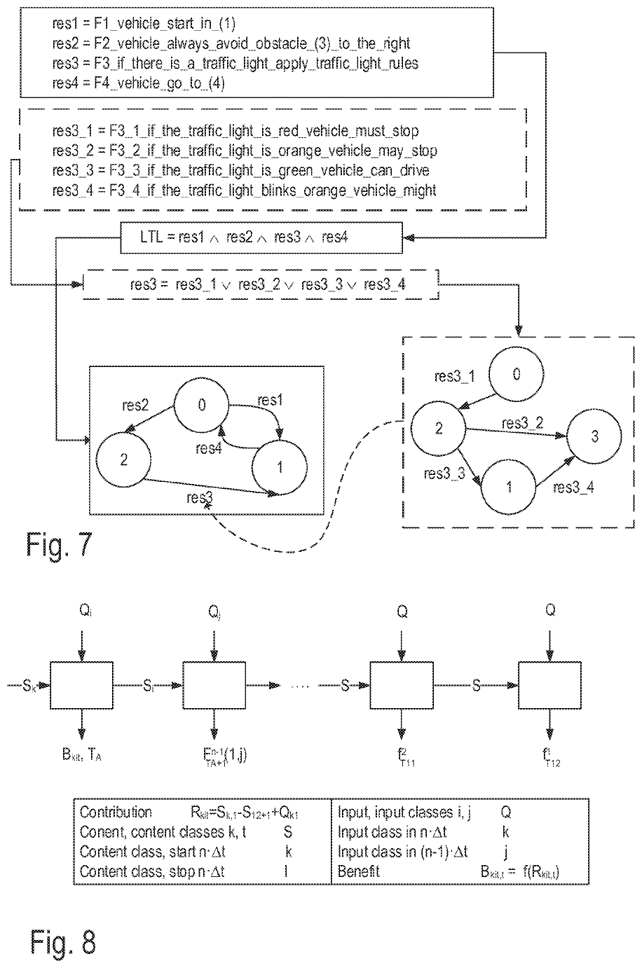

For a better understanding of the procedure it is graphically illustrated in FIG. 7. It is also possible that some keywords are included in the not translatable lines. This may be considered in future applications.

### (b) Mathematical Model

On the other side the mathematical model of the non-linear dynamics is given.

\dot{x}=f(x,u)

The dynamic model is discretized which also results in an automaton (state machine). The discretization can be done in different ways. The most common and best known way is to discretize the system is linearization of the generally non-linear dynamics using the Jacobi Matrix. The result of the linearization is a timed automaton where the discrete states of the automaton are discrete time stamps and the jump functions is the sample time. FIG. 8 shows the results of this discretization.

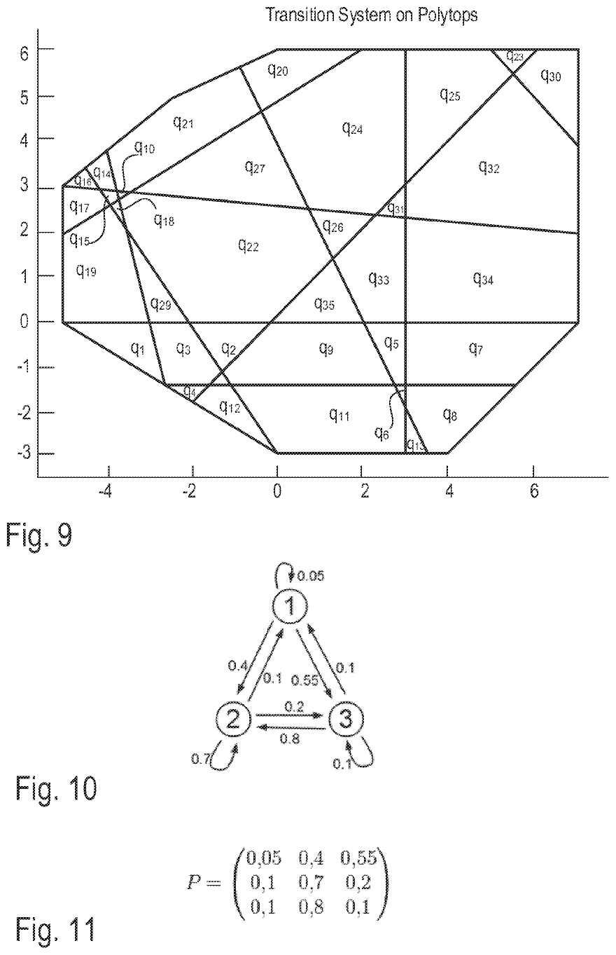

Another approach is the environment-driven discretization where a working area is divided into different sub-areas as shown in FIG. 9. The individual sub-areas can be marked as occupied or not occupied. In FIG. 9 an area is represented a polytope where one discrete state qᵢ is represented as the center of a polytope. Pages 11ff. of the publication M. Althoff, Reachability Analysis and its Application to the Safety Assessment of Autonomous Cars, PHD-thesis, TU München, 2010, shows different ways to represent polytopes based on line half-space (H-) representation or based on vertex (V-) space representation. There are other ways to represent polytopes (see FIG. 10).

Within one discrete (sub-) area the conditions (such as unoccupied, occupied, etc.) are the same. The discrete automaton can then be seen as a transition system from one discrete point to another and be represented as a transition matrix. FIG. 10 represent the transition system for 3 discrete state q₁=1, q₂=2 and q₃=3. The jump functions (i.e. transition functions) are the distances between the discrete states according to a predefined metric (they could be also 0 for no connection between two discrete state and 1 for a connection, however, also a value between 0 and 1, which represents a probability, could be possible). FIG. 11 shows the transition matrix of the transition system in FIG. 10.

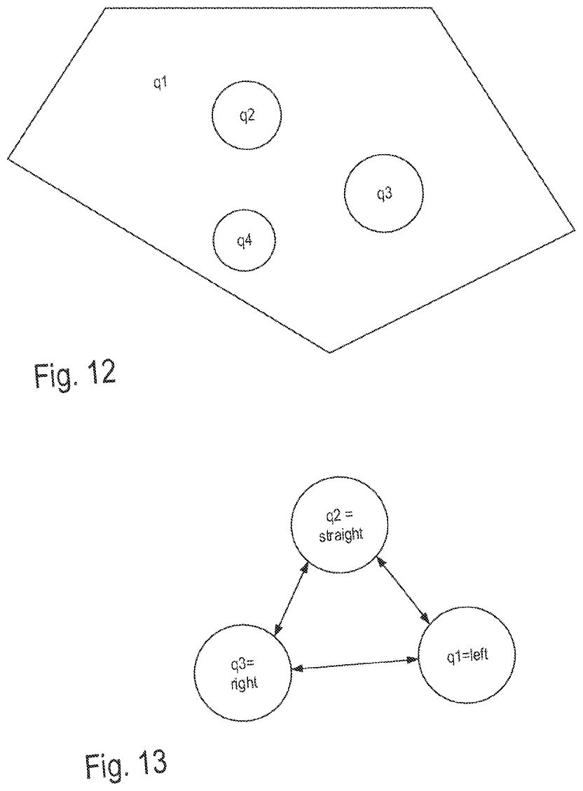

There might be other ways to discretize the operating environment (working area). For example, an environmental driven discretization of the non-linear dynamics could be represented as circles (encompassing occupied parts of the environment) with a predefined radius. FIG. 12 shows the discrete environment as

q₁\(q₂∩_{q3}∩q₄).

A controller-based or behavior-based discretization can be using the following procedure. Here a differential equation as it is commonly used in order to describe the dynamics of vehicles like aircrafts or cars is used. In the literature this is also known as “Dubins car”.

\dot{x}=v·cos(ψ)

\dot{y}=v·sin(ψ)

\dot{ψ}=ω

ω=[ωₘᵢₙ,0,ωₘₐₓ]

v=[vₘᵢₙ,0,vₘₐₓ]

u=[v,ω]

For the following cases the discrete automata can be defined as (see FIG. 13)
ω=ωₘᵢₙ<0 . . . q₁=left
ω=0 . . . q₂=straight
ω=ωₘₐₓ>0 . . . q′=right

The discrete transition function can be defined according a metric or a based on physical, graphical or stochastically functions. It is also possible to use discretize v and ω in predefined discretization steps n_{dist} so that

$$ω = [ {ω}_{m i n} , {ω}_{m i n} + i \cdot \frac{{ω}_{m a x} - {ω}_{m i n}}{{n}_{dist}} , … , {ω}_{m a x} ] , i ∈ [ 1 … {i}_{m a x} ] .$$

### (c) Automatic Test Generation

Applying the cross product to the two automata (state machines) gives a new state machines which is the automatically generated test as seen in FIG. 4 which is also called verification. If the result of the automata is positive the verification is positive which means that the automata of the model satisfies the specifications. The mathematical background for the cross product can be found on p. 11 of the publication Bruno Filipe Araujo Lacerda, “Linear-Time Temporal Logic Control of Discrete Event Systems”, Master Thesis, Universidade Téchnica de Lisboa, September 2007.

Instead of using all discrete states of the state machine of the model it is also possible to use only one state in order to do the verification.

### (d) Code Generation for Automatically Generated Test and Deployment on Target Hardware

A program then uses the resulting state machine in order to automatically generate it into C/C++ code or in Verilog/VHDL code or any other programming language. Verilog/VHDL is used in order to accelerate the verification process. Using standard development programs for FPGAs the source code then deployed onto the FGPA.

### (e) Implementation of the Function

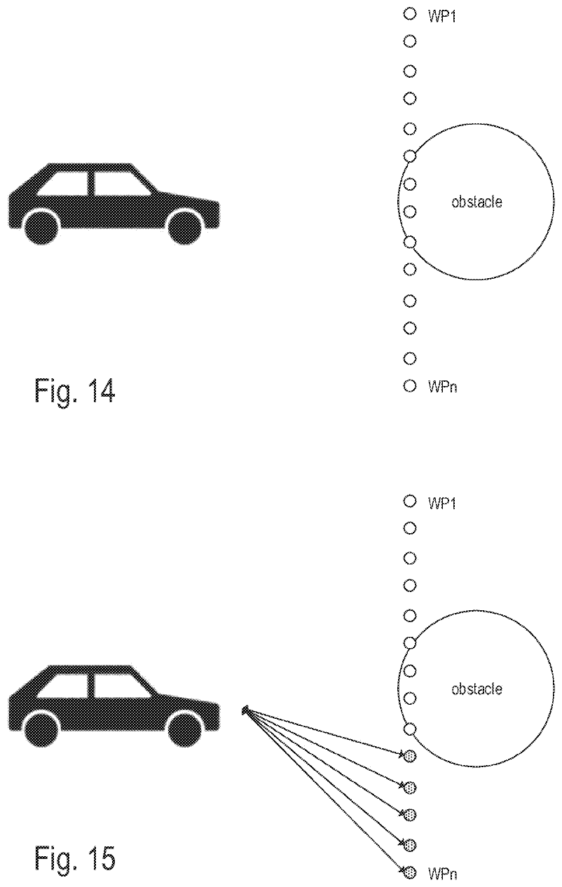

After the function interface is generated the function must be implemented such that the behavior of the function fulfills the written sentence. This is typically done in a simulation environment like Matlab. As example consider the following sentence:
avoid obstacle (3) to the right
   which means that the autonomous system must avoid the obstacle to the right (which is one of the main behaviors required by the rules of the air in order to integrate UAVs into the civil airspace). As shown in FIG. 14 the question which must be answered is which of the way points WP1, . . . , WPn satisfies the written specification. So the function must contain a test which generates a positive result to the collision avoidance of the car to right. In order to do that the function needs to have the information about the distance to the obstacle, the velocity and the heading of the car, the cars dynamic behavior (turning radius in relation to velocity) and the information if a waypoint WPi is reachable.

The reachability of a potential waypoint WPi can be calculated in different ways. One way to do it is to use symbolic available results for Dubins car as presented by on pp 28, in the publication Matthias Althoff, Reachability Analysis and its Application to the Safety Assessment of Autonomous Cars, PHD-thesis, TU München, 2010, and publication Marius Kloetzer, Symbolic Motion Planning and Control, PHD-thesis, Boston University, 2008.

Assuming now that there is a method implemented which solves the reachability problem for a given dynamics a test in the function has to calculate the results as shown in FIG. 15. The red dots show potential waypoints which do not satisfy the specification that the car should avoid the obstacle to the right and the green dots (marked with arrows) show that they satisfy the specifications.

The generated function will use the input of a sensor which is able to detect the obstacle and the velocity, heading and the steering angle of the car. The function returns as a return value
0 (red dots) if the waypoint does not satisfy the specification
1 (green dots) if the waypoint does satisfy the specification
   Additionally, the function can return the minimum and maximum values for the set points of the velocity and steering angle controller of the car.

### (f) Code Generation of the Function and Testing

In the next step the high level code function developed in the last step is automatically generated into a source code which can be used on the target board. Additionally, module tests are automatically generated so that the automatic generated source code can be tested against the high level function. Such test may include:
Function test,
Black box test,
Probabilistic test,
Interface test,
Performance test,
Software-in-the-loop tests.
   These tests are then applied to the code generated functions and compared to the high level code functions.

### (g) Integration Tests

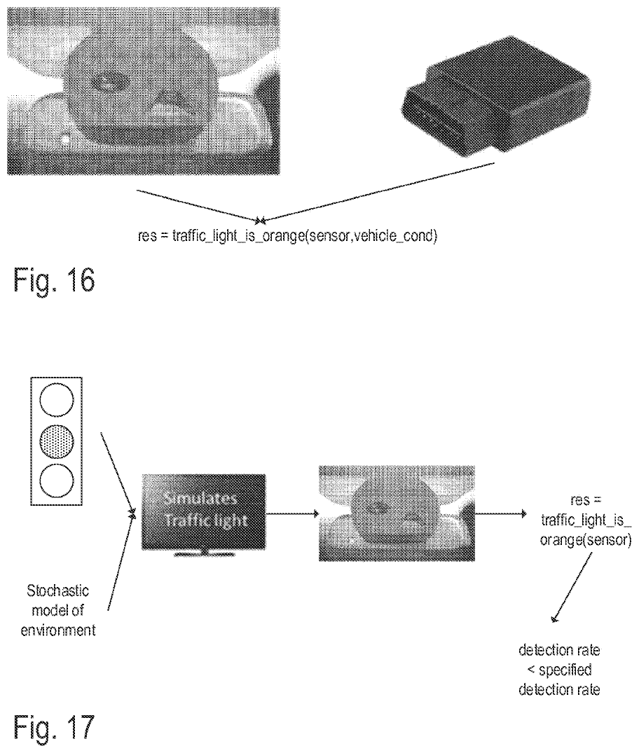

As described above for each functions requirements are defined either by the customer or FMEA analysis. In order to prove that a subsystem satisfies the requirements integration tests have to be developed. FIG. 16 illustrates the integration of a camera as an OBD device associated with a function (e.g. traffic_light_is_orange(sensor, vehicle_cond)).

FIG. 17 shows a potential setup of an integration test for a camera which should detect the orange color of a traffic light. The traffic light is displayed on a screen in different sizes in order to simulate the distance to the camera. To simulate the environmental conditions a stochastic model is used in order to produce noise which is added to the simulated traffic light. The camera is mounted in the test rig and look onto the screen. The images are forwarded to the “traffic_light_is_orange” function and the result of the function is forwarded. The testing computer counts the number of detection. The test is repeated until the necessary number of tests is reached. The achieved detection rate is compared to the specified detection rate. In the case that the detection rate is below the specified detection rate the subsystem is mounted onto the autonomous system is ready to be used. In the case it is not fulfilled, adjustments to the subsystem have to be made and the V-model is repeated.

### (h) Adjustment

In the case that during operation a situation arises which is not covered by the existing specification a special case specification is added to the existing specification. The whole development procedure according the V-model is repeated so that the special case can be handled by the autonomous system.

### (i) Deploying to the System

The automatically generated VHDL/Verilog code and the tested sub-system are implemented on the autonomous system. Each subsystem delivers a result to the state machine for verification.

### (j) Scientific Background

Claire Tomlin et al. (Tomlin, Claire, Ian Mitchell, Alexandre. M. Bayen, Meeko Oishi, 2003, Computational Techniques for the Verification of Hybrid Systems, Proceedings of the IEEE, pp. 986-1001) outlined the reachability analysis based on state space exploration as the major tool to verify Hybrid systems. Hybrid systems are systems which combine discrete and continuous dynamics to one model. Methods to solve the reachability problem can be divided into over-approximation methods and convergent approximation methods.

Over-approximating methods try to efficiently over-approximate the reachable set while the state representation typically scales polynomial with the continuous state space dimension n, with some exceptions. Since the execution time and memory requirement generally scales linearly with the size of the reachable state representation such methods have a significant advantage over other methods. On the other side the come with the disadvantage that the methods are to imprecise to cover non-linear dynamics and for which the shape of the reachable set is not a polygon or an ellipse.

Convergent approximating methods try to represent the reachable set as closely as possible while the state representation scales exponentially with n. This result to the fact that these methods are not practical for dimensions larger than five, but come with the advantage that non-linear dynamics can be covered and they make no assumptions on the shape of the reachable set.

Matthias Althoff (Matthias Althoff, Reachability Analysis and its Application to the Safety Assessment of Autonomous Cars, phd-thesis, TU München, 2010) uses idea of over-approximation in and applies it to non-linear systems by linearizing them around a working point and integrating them. He uses polygons to describe the reachable sets of the system after each integration step. He extends the idea to so-called stochastic state safety verification where he proposes to abstract a Markov-Chain out of the original hybrid dynamics. This is done by discretization of the continuous dynamics, resulting in state space regions which are defined as the discrete states of the Markov-Chain. The advantage of this method is that it is possible to derive control strategies which can minimize the risk of a collision while the disadvantage of this method is the exponential growth of the discrete states with the number of continuous states. Over the last couple of years he applied this techniques to different applications like safety verification of autonomous cars or automatic landing of helicopters.

So far the outlined methods are used to solve the typical robot navigation problem “Go from A to B and avoid collisions”. Such specifications can be formulated as inequalities, e. g. as circles around the point which should be reached or which should be avoided. More expressive specifications like “Always avoid a collision to the right” (as stated in the rules of the air) might be of interest.

Marius Kloetzer and Calin Balta (see Marius Kloetzer, Symbolic Motion Planning and Control, phd-thesis, Boston University, 2008, ISBN 054954729, and Marius Kloetzer, Calin Belta, A fully automated framework for control of linear systems from temporal logic specifications, IEEE Transaction on Automatic Control, 2008) proposed two methods that focus on more expressive specifications and which are not based on state space exploration but on the environment-driven discretization also called top-down approach and a controller-driven discretization also called bottom-up approach. The approach proposed in these works are between the both mentioned methods. Besides the advantage to use more expressive specifications in form of linear temporal logic (LTL) another advantage is the reduction of the number of discrete state spaces which gives a clear advantage in terms of time and memory requirement.

Luis Reyes Castro et al. (Luis I. Reyes Castro, Pratik Chaudhari, Jana Tumovay. Sertac Karaman, Emilio Frazzoli, Daniela Rus, Incremental Sampling-based Algorithm for Minimum-violation Motion Planning, Decision and Control (CDC), 2013 IEEE 52nd Annual Conference on, 3217-3224) showed probably the first time an implementation of a verified control algorithm which is able to handle safety rules (rules of the road) while fulfilling a given reachability task. The proposed solution is based on a Rapidly-exploring Random Trees (RRTs) algorithm which incrementally designs a feasible trajectory for a real time application. Since the proposed approach is iterative, as understood, so still running while already executing the action, the results can lead to very dangerous situations. As proposed in their paper a car does a lane change to do a takeover maneuver, but the path planning algorithm (MVRRT*) could still be running trying to find a feasible trajectory to come back to the original lane. Meanwhile a car approaching on the takeover lane is not yet being considered in the calculations of the path planning algorithm. This example could quickly lead to a dangerous maybe deadly situation. MVRRT* is of order m\hat{ }2*log(n) where m is the number of new samples added to a sample.

Most of the proposed state space exploration algorithms leak on the problem of not knowing the number n (number of states) necessary to solve the reachability problem, only Kloetzer and Calin could answer this problem partially.

### (k) Conclusion and Summary

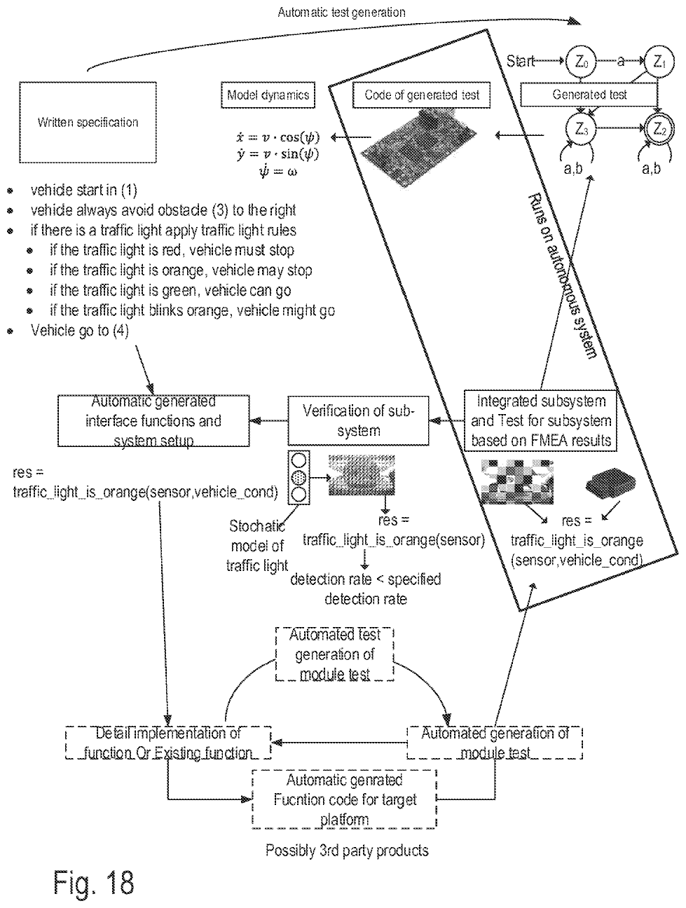

Some important aspects of the above description is summarized below. An example of the automation of the system development process according to the V-model is summarized with reference to FIG. 18. The basic input data used in the computer-assisted development process are a dynamic model of the mechatronic system (see above, section (b), and FIG. 18, “Model Dynamics”) and a textual system description (see above, section (a), and FIG. 18, “Written Specification”), which is a human-readable text including keywords and text passages linked by the keywords. The keywords represent logic operators and modal temporal operators of a linear temporal logic (LTL).

The textual system description is automatically decomposed using a computer and software configured to decompose the textual system description into the keywords and the text passages linked by the keywords. The individual text passages (e.g. “traffic light is orange vehicle must stop”) are converted into function definitions (e.g. “traffic_light_is_orange(sensor, vehicle_conditions)”) and the keywords are converted into operators of a linear temporal logic. The functions' return values are Boolean values. Software for parsing and interpreting text is as such known and therefore not further details are discussed here. Once the textual system description is decomposed in keywords (operators) and the functions definitions, an LTL formulae can be derived therefrom. This is also accomplished by a computer and appropriate software. As mentioned above, the LTL formulae is converted into a Büchi automaton. Algorithms for this are also as such known and are implemented in software.

The dynamic model of the mechatronic system is discretized and the resulting discrete system is also converted into an automaton. Modeling discrete systems using automata is as such known and not further discussed here. Thereby, “conversion into an automaton” means deriving/generating a mathematical model representing the automaton.

At this point, two automata have been generated. A first automaton representing the textual system description and a second automaton representing the dynamics of the mechatronic system. These two automata can be combined, e.g. by applying a “cross-product” (see above, sections (c), FIG. 18, “Generated Test”). The theory of this cross-product is also known and corresponding citations are provided above. The result is another automaton (test automaton), which may be used for automatic testing when executed by the mechatronic system. During operation of the mechatronic system (e.g. while an autonomous car is driving) the test automaton is able to check the current status of the system for compliance with the requirements/rules specified in the textual system description.

The mentioned testing automaton executes the functions for which the function definitions have been previously generated automatically as mentioned above. The remaining engineering/development task is the implementation and verification of these functions with specific sensors (e.g. a camera for traffic light detection, whose sensor output is processed by the function traffic_light_is_orange(sensor, vehicle_conditions)).

Finally, the testing automaton can be automatically converted in a hardware description language (e.g. VHDL, Very High Speed Integrated Circuit Hardware Description Language) and implemented in a programmable logic such as an FPGA (field programmable gate array) or the like. On the target system, the testing automaton is executed, e.g. in the FPGA, and continuously checks the set-points (e.g. a waypoint for an autonomous car) of a controller, which controls the mechatronic system, whether they are compliant with the requirements/rules specified in the textual system description. In fact, the set of controller set-points is limited to those set-points which are detected as compliant with the textual system description.

Using the concept of computer-assisted development a testing automaton can be generated which is executed—during system operation—on a dedicated piece of hardware (e.g. an FPGA). When designed according to the concept described herein, the testing automaton is able to eliminate controller set-points which are not compliant with the (human-readable) textual system description, which is an important factor for functional safety of a system.

The software used for parsing the textual system description, the generation of the LTL formulae, the discretization of the system dynamics, the generation of the automata as mentioned above and the combination of the automata to generate the testing automaton, the conversion of the automaton into VHDL may be provided in an integrated development environment which provides all the mentioned software tools, which implement the methods described herein. The mentioned functions, whose definitions result from the textual system description (such as traffic_light_is_orange(sensor, vehicle_conditions)) may be provided in a software library for specific sensors. The performance of the functions in connections with one or more specific sensors (e.g. a camera) may be tested and verified separately. Once the performance of a function and a specific sensor (e.g. a specific camera) has been verified, it can be used in the mechatronic system. The compliance of the overall system is guaranteed by the nature of the design concept. method described herein

What is claimed is:

1. A method for computer-assisted system design, the method comprising:
providing a textual system description that defines a desired behavior of a vehicle;
converting, using a computer, the textual system description into a linear temporal logic (LTL) formula;
converting, using the computer, the LTL formula into a first automaton;
providing, using the computer, a second automaton representing system dynamics of the vehicle; and
generating, using the computer, a testing automaton by combining the first and the second automaton.

2. The method of claim 1, further comprising:
generating a hardware description language (HDL) model of the testing automaton; and
implementing, using the computer, the testing automation in hardware.

3. The method of claim 1, wherein converting the textual system description into the LTL formula comprises:
decomposing the textual system description into keywords, which represent logic operators and modal temporal operators of a linear temporal logic (LTL), and text passages linked by the keywords;
generating, using the computer, software function definitions corresponding to the text passages linked by the keywords; and
generating the LTL formula based on the software function definitions and the operators defined by the keywords.

4. The method of claim 1, wherein providing the second automaton representing the system dynamics comprises:
providing a model representing the system dynamics of the vehicle;
discretizing the model to obtain a discrete model; and
converting the discrete model into an automaton.

5. The method of claim 1, wherein the textual system description is automatically enhanced to include redundancy.

6. The method of claim 1, wherein the textual system description includes a set of traffic rules.

7. A controller module for controlling a vehicle, the controller module comprising:
a controller configured to execute a controller task to control the vehicle;
a programmable logic configured to execute a testing automaton designed by converting a textual system description that defines a desired behavior of the vehicle into a linear temporal logic (LTL) formula, converting the LTL formula into a first automaton, providing a second automaton representing system dynamics of the vehicle, and generating the testing automaton by combining the first and the second automaton; and
at least one sensor configured to obtain sensor information,
wherein the controller is configured to provide one or more set-points representing the movement of the vehicle to the programmable logic,
wherein the programmable logic is configured to check, based on the sensor information, whether the one or more set-points are compliant with desired behavior of the vehicle defined by the textual system description.

8. The controller module of claim 7, wherein the textual system description includes a set of traffic rules.

9. A non-transitory computer readable medium storing a computer program operable for computer-assisted system design, the computer program comprising:
program instructions to convert a textual system description that defines a behavior of vehicle into a linear temporal logic (LTL) formula;
program instructions to convert the LTL formula into a first automaton;
program instructions to provide a second automaton representing system dynamics of the vehicle; and
program instructions to generate a testing automaton by combining the first and the second automaton.

10. The non-transitory computer readable medium of claim 9, wherein the computer program further comprises:
program instructions to generate a hardware description language (HDL) model of the testing automaton; and
program instructions to implement the testing automation in hardware.

11. The non-transitory computer readable medium of claim 9, wherein the program instructions to convert the LTL formula into the first automaton comprise:
program instructions to decompose the textual system description into keywords, which represent logic operators and modal temporal operators of a linear temporal logic (LTL), and text passages linked by the keywords;
program instructions to generate software function definitions corresponding to the text passages linked by the keywords; and
program instructions to generate the LTL formula based on the software function definitions and the operators defined by the keywords.

12. The non-transitory computer readable medium of claim 9, wherein the program instructions to provide the second automaton representing the system dynamics of the vehicle comprise:
program instructions to provide a model representing the system dynamics;
program instructions to discretize the model to obtain a discrete model; and
program instructions to convert the discrete model into an automaton.

13. The non-transitory computer readable medium of claim 9, wherein the textual system description includes a set of traffic rules.
